(19) United States
(12) Patent Application Publication
(10) Pub. No.: US 2013/0075205 A1
(43) Pub. Date: Mar. 28, 2013

(54) DISK BRAKE APPARATUS

(71) Applicant: HITACHI AUTOMOTIVE SYSTEMS, LTD., Ibaraki (JP)

(72) Inventors: Takayasu SAKASHITA, Kanagawa (JP); Jun WATANABE, Kanagawa (JP)

(73) Assignee: HITACHI AUTOMOTIVE SYSTEMS, LTD., Ibaraki (JP)

(21) Appl. No.: 13/626,484

(22) Filed: Sep. 25, 2012

(30) Foreign Application Priority Data
Sep. 28, 2011 (JP) 212782/2011

(51) Int. Cl. B60T 1/06

(52) U.S. Cl. 188/72.3

(57) ABSTRACT

The present invention provides a disk brake in which the respective components are arranged in such a manner that a distance between a central axis of a first reduction gear for transmitting a rotation of a motor to a cylinder portion side while slowing down the rotation, and a central axis of a cylinder portion is longer than a distance between a rotational axis of the motor and a central axis of the cylinder portion.

### TECHNICAL FIELD

The present invention relates to a disk brake apparatus used in braking a vehicle.

### BACKGROUND ART

As one of conventional disk brake apparatuses, Japanese Patent Application Public Disclosure No. 2010-169248 discloses a disk brake apparatus including a multi-stage spur gear reduction mechanism, which is constituted by a first reduction gear and a second reduction gear, between an electric motor and a planetary gear reduction mechanism. In this disk brake apparatus, a large gear of the first reduction gear and a large gear of the second reduction gear are positioned so as to axially overlap each other.

However, the disk brake disclosed in Japanese Patent Application Public Disclosure No. 2010-169248 has a problem with mountability to a vehicle due to a long axial length of a caliper.

### SUMMARY OF THE INVENTION

According to an aspect of the present invention, a disk brake apparatus includes a pair of pads disposed on opposite sides of a disk rotor, a piston configured to press one of the pair of pads against the disk rotor, a caliper main body including a cylinder in which the piston is movably disposed, an electric motor disposed at the caliper main body and arranged in alignment with the cylinder in a circumferential direction of the disk rotor, a speed reduction mechanism capable of transmitting a rotational force from the electric motor while increasing the rotational force by a plurality of rotational members, and a piston thrust mechanism to which the rotational force is transmitted from the speed reduction mechanism, the piston thrust mechanism being configured to move forward the piston to a braking position. The plurality of rotational members includes a first rotational member and a second rotational member. The first rotational member is disposed in such a manner that the rotational force is transmitted from the electric motor to the first rotational member. The first rotational member includes a large-diameter rotational portion connected to the electric motor, and a small-diameter rotational portion formed coaxially with the large-diameter rotational portion and connected to a transmission member configured to transmit the rotational force to the second rotational member. The first rotational member is disposed in such a manner that a distance between a central axis of the first rotational member and a central axis of the cylinder is longer than a distance between a rotational axis of the electric motor and the central axis of the cylinder.

According to another aspect of the present invention, a disk brake includes a caliper main body including a cylinder in which a piston is movably disposed. The piston is configured to press one of a pair of pads against a disk rotor. The pair of pads is disposed on opposite sides of the disk rotor. The disk brake further includes an electric motor disposed at the caliper main body and arranged in alignment with the cylinder in a circumferential direction of the disk rotor, a speed reduction mechanism capable of transmitting a rotational force from the electric motor while increasing the rotational force by a plurality of rotational members, and a piston thrust mechanism disposed coaxially with the cylinder and configured to move forward the piston when the rotational force is transmitted from the speed reduction mechanism. The plurality of rotational members includes a first rotational member. The first rotational member is disposed in such a manner that the rotational force is transmitted from the electric motor to the first rotational member. The first rotational member comprises a stepped reduction gear. A central axis of the first rotational member is disposed at a position farther away from the cylinder than a rotational axis of the motor.

According to still another aspect of the present invention, a disk brake includes a bracket including a fixation portion fixed to a non-rotatable portion of a vehicle, and configured to slidably support a pair of pads disposed on opposite sides of a disk rotor, a piston configured to press one of the pair of pads against the disk rotor, a caliper main body including a cylinder in which the piston is slidably disposed, and slidably disposed at the bracket via a slide pin, an electric motor disposed at the caliper main body and arranged in alignment with the cylinder in a circumferential direction of the disk rotor, a speed reduction mechanism capable of transmitting a rotational force from the electric motor while increasing the rotational force by a plurality of rotational members, and a piston thrust mechanism configured to move forward the piston when the rotational force is transmitted from the speed reduction mechanism. The plurality of rotational members includes a first rotational member and a second rotational member. The first rotational member is disposed in such a manner that the rotational force is transmitted from the electric motor to the first rotational member. The first rotational member includes a large-diameter rotational portion connected to the electric motor, and a small-diameter rotational portion formed coaxially with the large-diameter rotational portion and connected to a transmission member configured to transmit the rotational force to the second rotational member. The first rotational member is disposed between the fixation portion and the slide pin in a radial direction of the disk rotor.

### BRIEF DESCRIPTION OF THE DRAWINGS

FIG. 1 is a cross-sectional view illustrating a disk brake apparatus according to an embodiment of the present invention;

FIG. 2 is an enlarged cross-sectional view illustrating a cylinder portion of a caliper main body illustrated in FIG. 1;

FIG. 3 illustrates the disk brake apparatus as viewed from a direction indicated by an arrow A in FIG. 1;

FIG. 4 illustrates the disk brake apparatus as viewed from a direction indicated by an arrow B in FIG. 3;

FIG. 5 is an exploded perspective view illustrating a reduction mechanism in FIG. 1;

FIG. 6 is a plan view illustrating the reduction mechanism in FIG. 1;

FIG. 7 is a cross-sectional view illustrating a modification of a multi-stage spur gear reduction mechanism in FIG. 1; and

FIG. 8 is a plan view illustrating a reduction mechanism including the multi-stage spur gear reduction mechanism in FIG. 7.

### DESCRIPTION OF THE EMBODIMENTS

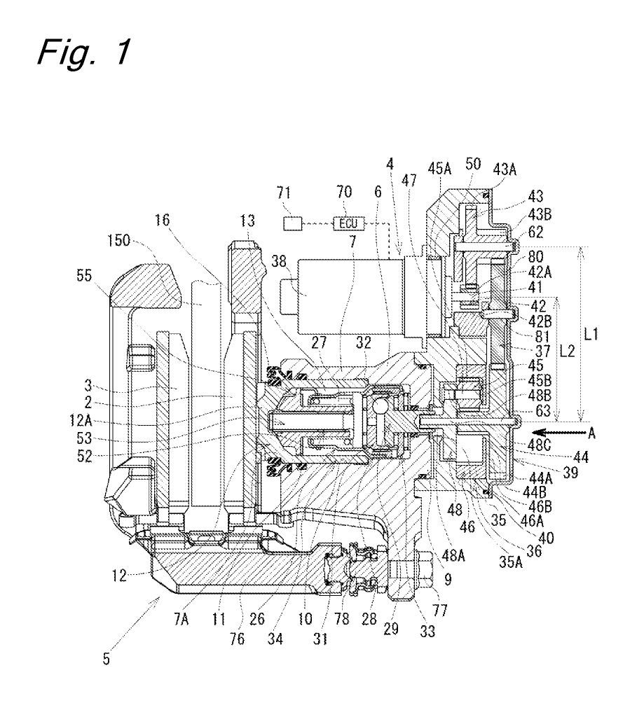

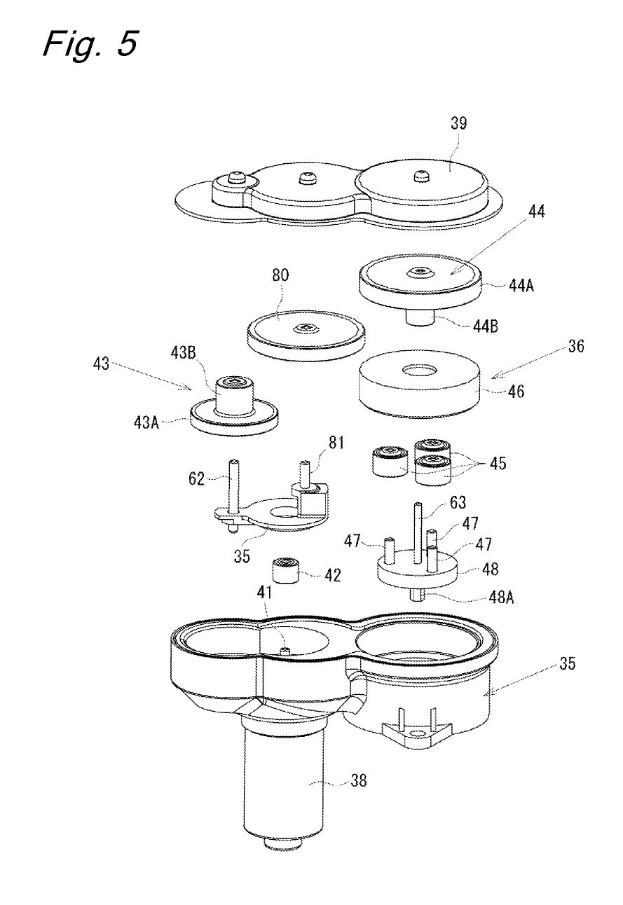

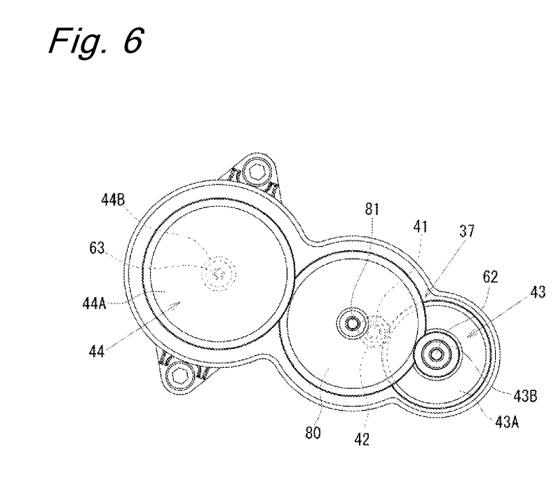

A disk brake apparatus 1 according to an embodiment of the present invention will be described in detail with reference to FIGS. 1 to 8. As illustrated in FIG. 1, the disk brake apparatus 1 according to the present embodiment includes a pair of inner brake pad 2 and outer brake pad 3 disposed on the opposing sides of a disk rotor 150 attached to a rotational portion of a vehicle, and a caliper 4. The disk brake 1 is configured as a caliper floating-type disk brake. The pair of inner brake pad 2 and outer brake pad 3, and the caliper 4 are supported by a bracket 5 fixed to a non-rotatable portion such as a knuckle of the vehicle via a fixation unit so as to be movable in an axial direction of the disk rotor 150.

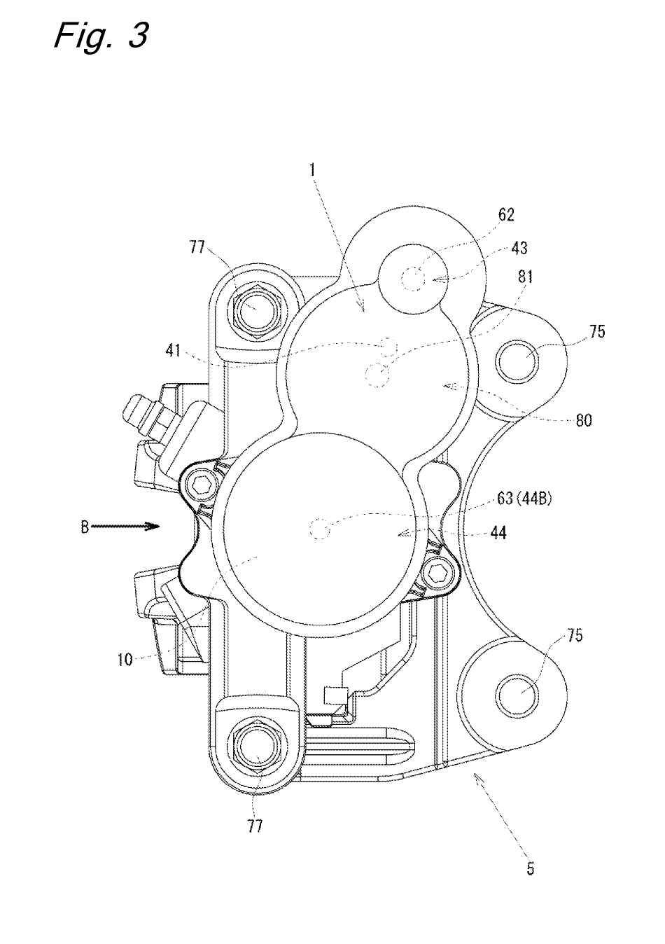

In other words, as illustrated in FIG. 3, the bracket 5 includes a pair of bolt holes 75 as the fixation unit fixed to the non-rotatable portion of the vehicle. The bracket 5 is fixed to the non-rotatable portion of the vehicle by an attachment bolt (not illustrated) inserted through each of the bolt holes 75. Further, as illustrated in FIGS. 1, 3, and 4, the bracket 5 includes a pair of attachment axial portions 76 formed to extend in the axial direction of the disk rotor 150 at positions spaced-apart from the bolt holes 75 along the circumferential direction of the disk rotor 150. The pair of attachment axial portions 76 each have a not-illustrated attachment hole therethrough. Slide pins 78 are axially slidably disposed in the attachment axial portions 76 of the bracket 5, respectively. The slide pins 78 are fixed to the caliper 4 (a cylinder portion 7) of the disk brake 1 by bolts 77. The caliper 4 is slidably supported by the bracket 5 by the insertion of the slide pins 78 in the respective attachment axial portions 76 in this way.

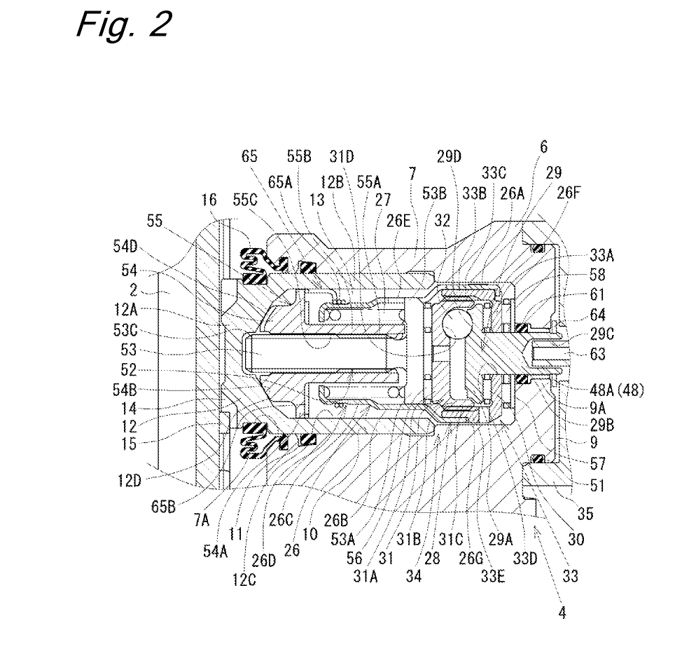

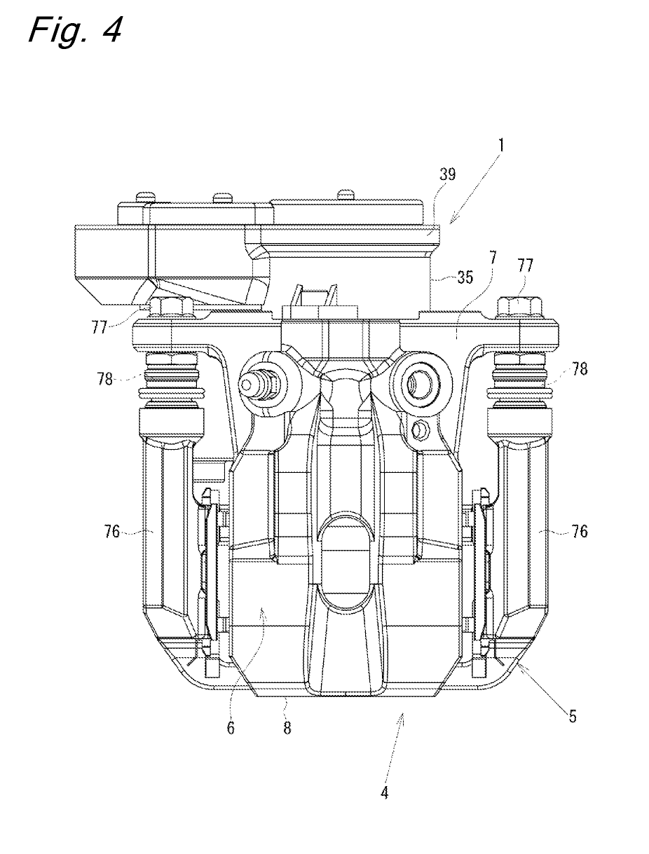

The caliper 4 generally includes a caliper main body 6, a piston 12, and a housing 35, which will be described below. As illustrated in FIGS. 1 and 4, the caliper main body 6, which is a main body of the caliper 4, includes the cylinder portion 7 disposed at a proximal end side facing the inner brake pad 2, which is a brake pad at the inner side of the vehicle, and a claw portion 8 disposed at a distal end side facing the outer brake pad 3, which is a brake pad at the outer side of the vehicle. The cylinder portion 7 includes an opening portion 7A at the end closer to the inner brake pad 2, and a bottomed bore 10 at the other end. The bottomed bore 10 is closed by a bottom wall 9 including a hole portion 9A (refer to FIG. 2). A piston seal 11 is disposed in the bore 10 in a circumferential groove formed at the opening side.

As illustrated in FIG. 2, the piston 12 is formed into a bottomed cup shape, and is contained in the bore 10 in such a manner that a bottom portion 12A of the piston 12 faces the inner brake pad 2. The piston 12 is contained in the bore 10 axially slidably in contact with the bore 10 via the piston seal 11. A hydraulic pressure chamber 13 is formed between the piston 12 and the bore 10 by being defined by the piston seal 11. A hydraulic pressure is supplied from a not-illustrated hydraulic pressure source such as a master cylinder or a hydraulic pressure control unit to the hydraulic pressure chamber 13 via a not-illustrated port formed at the cylinder portion 7. The piston 12 includes a recess portion 14 formed at a bottom surface thereof. A protrusion portion 15 formed on a back surface of the inner brake pad 2 is engaged with the recess portion 14, thereby preventing the piston 12 from rotating relative to the bore 10, and thus the caliper main body 6. Further, a dust boot 16 is disposed between the bottom portion 12A of the piston 12 and the bore 10 to prevent an entry of foreign objects into the bore 10.

As illustrated in FIG. 1, the housing 35 is air-tightly attached outside the bottom wall 9 of the bore 10 of the caliper main body 6. A cover 39 is air-tightly attached to one end opening of the housing 35. As illustrated in FIG. 2, air-tightness is maintained by a seal 51 between the housing 35 and the bore 10. Further, as illustrated in FIG. 1, air-tightness is maintained by a seal 40 between the housing 35 and the cover 39. A motor 38, which is an example of an electric motor, is sealingly attached to the housing 35 via a seal 50. In the present embodiment, the motor 38 is disposed outside the housing 35, but the housing 35 may be formed so as to cover the motor 38 so that the motor 38 is contained in the housing 35. In this case, the seal 50 becomes unnecessary, thereby reducing the number of assembling processes.

As illustrated in FIG. 1, a piston thrust mechanism 34, which is configured to move forward the piston 12 to a braking position, and a multi-stage spur gear reduction mechanism 37 and a planetary gear reduction mechanism 36 as a speed reduction mechanism, which are configured to increase a rotational force generated by the motor 38 (power up a rotation of the motor 38), are disposed in the caliper 4. The piston thrust mechanism 34 is contained in the caliper main body 6, and the multi-stage spur gear reduction mechanism 37 and the planetary gear reduction mechanism 36 are contained in the housing 35. A rotational force of a rotational shaft 41 of the motor 38 is directly transmitted from a pinion gear 42 of the motor 38 to the multi-stage spur gear reduction mechanism 37, and is transmitted from the multi-stage spur gear reduction mechanism 37 to the planetary gear reduction mechanism 36, and then is transmitted to the piston thrust mechanism 34.

The piston thrust mechanism 34 includes a ball and ramp mechanism 28 and a screw mechanism 52, and is configured to convert a rotational motion from the planetary gear reduction mechanism 36 into a motion in the linear direction (hereinafter referred to as “linear motion” for convenience of description), and apply a thrust force to the piston 12 and advance the piston 12 to the braking position. The piston thrust mechanism 34 also functions to maintain the piston 12 at the braking position after advancing the piston 12 to the braking position. The ball and ramp mechanism 28 and the screw mechanism 52 are contained in the bore 10 of the caliper main body 6. The screw mechanism 52 is disposed between the ball and ramp mechanism 28 and the piston 12.

As illustrated in FIG. 1, the multi-stage spur gear reduction mechanism 37 includes the pinion gear 42 of the motor 38, a first reduction gear 43 as a first rotational member, which is meshed with the pinion gear 42, a non-reduction spur gear 80 as a transmission member, which is meshed with the first reduction gear 43 and does not reduce a speed, and a second reduction gear 44 as a second rotational member, which is meshed with the non-reduction spur gear 80. The pinion gear 42 of the motor 38 is formed into a cylindrical shape, and includes a hole portion 42A fixedly press-fitted around the rotational shaft 41 of the motor 38, and a gear 42B formed at the outer circumference of the pinion gear 42. The first reduction gear 43 includes a large gear 43A as a large-diameter rotational portion, which has a large diameter and is meshed with the gear 42B of the pinion gear 42, and a small gear 43B as a small-diameter rotational portion, which has a small diameter and is formed to axially protrude from the large gear 43A. The large gear 43A and the small gear 43B are integrally molded. The small gear 43B of the first reduction gear 43 is meshed with the non-reduction spur gear 80. The first reduction gear 43 is rotatably supported by a shaft 62 having one end supported by the housing 35 and the other end supported by the cover 39.

The second reduction gear 44 includes a large gear 44A having a large diameter and meshed with the non-reduction spur gear 80, and a small-diameter sun gear 44B formed to axially protrude from the large gear 44A. The large gear 44A and the sun gear 44B are integrally molded. The sun gear 44B of the second reduction gear 44 is configured as a part of the planetary gear reduction mechanism 36, which will be described below. The second reduction gear 44 is rotatably supported by a shaft 63 supported by the cover 39. The non-reduction spur gear 80 is meshed with the small gear 43B of the first reduction gear 43 and the large gear 44A of the second reduction gear 44. The non-reduction spur gear 80 is rotatably supported by a shaft 81 having one end supported by the housing 35 and the other end supported by the cover 39. In the present embodiment, the first reduction gear 43 and the second reduction gear 44 each include the integrally molded large-diameter gear and small-diameter gear. However, the present invention is not limited thereto. As long as the large-diameter gear and the small-diameter gear are integrally joined, the large-diameter gear and the small-diameter gear may be configured as separate members fixed to each other by, for example, fitted engagement, bonding, or screwing. Further, they may be even spaced apart from each other while they are fixed to a same shaft.

The planetary gear reduction mechanism 36 includes the sun gear 44B of the second reduction gear 44, a plurality of planetary gears 45 (three gears in the present embodiment), an internal gear 46, and a carrier 48. The planetary gears 45 each include a gear 45A meshed with the sun gear 44B of the second reduction gear 44, and a hole portion 45B through which a pin 47 erected from the carrier 48 is inserted. The three planetary gears 45 are equiangularly disposed along the circumference of the carrier 48.

As illustrated in FIGS. 1 and 2, the carrier 48 is formed into a disk shape, and a polygonal cylinder 48A is formed at the center of the disk to protrude in the direction toward the inner pad 2. The polygonal cylinder 48 of the carrier 48 is fitted in a polygonal hole 29C formed at a cylinder portion 29B of a rotational ramp 29 of the ball and ramp mechanism 28, which will be described below, and therefore can transmit a rotational torque between the carrier 48 and the rotational ramp 29. A plurality of pin holes 48B is formed at the outer circumferential side of the carrier 48. The pins 47 rotatably supporting the respective planetary gears 45 are fixedly press-fitted in the pin holes 48B. The carrier 48 and the respective planetary gears 45 are prevented from axially moving by a wall surface 35A of the housing 35 and an annular wall portion 46B integrally formed at the internal gear 46 on the end thereof facing the second reduction gear 44. Further, an insertion hole 48C is formed at the center of the carrier 48. The shaft 63, which is supported by the cover 39 and rotatably supports the second reduction gear 44, is fixedly press-fitted through the insertion hole 48C. In the present embodiment, a relative rotation is prevented between the carrier 48 and the rotational ramp 29 by the polygonal cylinder 48A formed at the carrier 48 and the polygonal hole 29C of the rotational ramp 29. However, the present invention is not limited thereto. The polygonal shape may be replaced with a chamfered cylindrical shape. Further, a relative rotation may be prevented between the carrier 48 and the rotational ramp 29 with use of a mechanical element capable of transmitting a rotational torque such as a spline or a key.

As illustrated in FIG. 1, the internal gear 46 includes internal teeth 46A meshed with the respective gears 45A of the planetary gears 45, and the annular wall portion 46B integrally formed continuously from the internal teeth 46A at the portion of the internal gear 46 closer to the second reduction gear 44 to prevent axial movements of the planetary gears 45. The internal gear 46 is fixedly press-fitted in the housing 35.

As illustrated in FIG. 1, the respective components are located in such a manner that a distance L1 between the central axis (the shaft 62) of the first reduction gear 43 and the central axis (the shaft 63) of the sun gear 44B is longer than a distance L2 between the rotational shaft 41 of the motor 38 and the central axis (the shaft 63) of the sun gear44B. Further, as illustrated in FIG. 3, the first reduction gear 43 is disposed between the bolt hole 75 of the bracket 5 and the attachment hole of the bracket 5, through which the slide pin 78 is inserted, in the radial direction of the disk rotor 150. Further, as seen from the illustration of FIG. 1, the small gear 43B of the first reduction gear 43, the non-reduction spur gear 80, and the large gear 44A of the second reduction gear 44 are arranged in such a manner that their respective surfaces facing the cover 39 are positioned on a substantially same plane.

As illustrated in FIG. 2, the screw mechanism 52 includes a push rod 53, and a nut 55 screwed with the push rod 53. The push rod 53 includes a flange portion 53A and a male screw portion 53C, which are integrally molded. The flange portion 53A is disposed to axially face a rotation/linear motion ramp 31 of the ball and ramp mechanism 28 via a thrust bearing 56. A coil spring 27 is disposed between the flange portion 53A and a retainer 26, which will be described below. The coil spring 27 constantly biases the push rod 53 toward the thrust bearing 56, i.e., toward the bottom wall 9 of the cylinder portion 7, thereby biasing the rotation/linear motion ramp 31 of the ball and ramp mechanism 28, which will be described below, toward the bottom wall 9 of the cylinder portion 7 via the push rod 53. The push rod 53 includes a plurality of protrusion portions 53B formed along the circumferential direction on the outer circumferential surface of the flange portion 53A. The respective protrusion portions 53B are configured to be fitted in a plurality of elongated grooves 26E formed along the circumferential direction at a reduced diameter portion 26B of the retainer 26, which will be described below. The fitted engagement between the protrusion portions 53B and the elongated groove portions 26E prevents the push rod 53 from moving in the rotational direction relative to the retainer 26 while allowing the push rod 53 to axially move within the range of the axial length of the elongated grooves 26E.

The nut 55 includes a cylindrical portion 55B including a hole portion 55A as a through-hole and formed at one end side (at the portion of the nut 55 closer to the bottom wall 9 of the cylinder portion 7), and a flange portion 54 formed at the other end side (at the portion of the nut 55 closer to the opening 7A of the cylinder portion 7). The cylindrical portion 55B and the flange portion 54 are integrally molded. Therefore, the nut 5 has a T shape in cross-section taken along the axial direction, and a mushroom shape in appearance. A female screw portion 55C, which is screwed with the male screw portion 53C of the push rod 53, is formed at the hole portion 55A within the range where the cylindrical portion 55B is formed.

A plurality of protrusion portions 54A is formed to be spaced apart in the circumferential direction at the outer circumferential end of the flange portion 54 of the nut 55. The protrusion portions 54A are configured to be engaged with a plurality of flat surface portions 12C, which is formed on the inner circumferential surface of a cylindrical portion 12B of the piston 12 to axially extend and be spaced apart in the circumferential direction. This engagement prevents the nut 55 from moving relative to the piston 12 in the rotational direction while allowing the nut 55 to move relative to the piston 12 in the axial direction. An inclined surface 54B is formed at the tip surface of the flange portion 54 of the nut 55. The inclined surface 54B can abut against an inclined surface 12D, which is formed at the inner side of a bottom portion 12A of the piston 12. The abutment of the inclined surface 54B of the flange portion 54 of the nut 55 against the inclined surface 12D of the piston 12 allows a rotational force from the motor 38 to be transmitted to the piston 12 via the push rod 53, the nut 55, and the flange portion 54, which are the screw mechanism 52. As a result, the piston 12 can move forward to the braking position. A plurality of grooves (not illustrated) is formed at the protrusion portions 54A of the flange portion 54 of the nut 55, and a plurality of grooves 54D is also formed at the inclined surface 54B of the flange portion 54 of the nut 55, so that communication can be established between a space surrounded by the bottom portion 12A of the piston 12 and the flange portion 54, and the hydraulic pressure chamber 13 to allow a flow of brake hydraulic fluid therebetween, thereby ensuring that air can be released from this space.

The male screw portion 53C of the push rod 53 and the female screw portion 55C of the nut 55 are arranged to form a screw having reversed efficiency of 0 or lower, i.e., having high irreversibility to prevent a base nut 33 from rotating due to an axial load applied from the piston 12 to the rotation/linear motion ramp 31.

As illustrated in FIG. 2, the ball and ramp mechanism 28 includes the rotational ramp 29, the rotation/linear motion ramp 31, a plurality of balls 32, and the base nut 33. The rotational ramp 29 includes a disk-shaped rotational plate 29A, and a cylindrical portion 29B integrally extending from a substantially central point of the rotational plate 29A toward the planetary gear reduction mechanism 36. In this way, the rotational ramp 29 has a T shape in cross-section taken along the axial direction thereof. The cylindrical portion 29B is inserted through an insertion hole 33D formed at a bottom wall 33A of the base nut 33, which will be described below, and the hole portion 9A formed at the bottom wall 9 of the bore 10. The polygonal hole 29C, to which the polygonal cylinder 48A formed at the carrier 48 is fitted, is formed at the tip of the cylindrical portion 29B. Further, a plurality of ball grooves 29D is formed at an opposite surface of the rotational plate 29A from the cylindrical portion 29B. Each of the ball grooves 29D extends to form a circular arc in the circumferential direction with a predetermined inclination angle, and has a circular arc shape in cross-section taken along the radial direction thereof. The rotational plate 29A is supported rotatably relative to the bottom wall 33A of the base nut 33 via a thrust bearing 30. A seal 61 is disposed between the hole portion 9A of the bottom wall 9 of the bore 10 and the outer circumferential surface of the cylindrical portion 29B of the rotational ramp 29, thereby maintaining liquid-tightness of the hydraulic pressure chamber 13. Further, a retaining ring 64 is attached to the tip of the cylindrical portion 29B of the rotational ramp 29 to prevent the rotational ramp 29 from moving relative to the caliper main body 6 toward the inner and outer brake pads 2 and 3 and moving in the axial direction of the rotor. Preventing the rotational ramp 29 from moving in this way further prevents the base nut 33 from axially moving relative to the caliper main body 6. Therefore, a female screw portion 33C formed at the base nut 33 is also prevented from axially moving relative to the caliper main body 6.

As illustrated in FIG. 2, the rotation/linear motion ramp 31 is formed into a bottomed cylindrical shape including a disk-shaped rotation/linear motion plate 31A, and a cylindrical portion 31B integrally extending from the outer circumferential edge of the rotation/linear motion plate 31A toward the planetary gear reduction mechanism 36. A plurality of ball grooves 31D, three ball grooves 31D in the present embodiment are formed at the surface of the rotation/linear motion plate 31A that faces the rotational plate 29A of the rotational ramp 29. Each of the ball grooves 31D extends to form a circular arc along the circumferential direction with a predetermined inclination angle, and has a circular arc shape in cross-section taken along the radial direction thereof. Further, a male screw portion 31C, which is screwed with the female screw portion 33C formed on the inner circumferential surface of the cylindrical portion 33B of the base nut 33, is formed on the outer circumferential surface of the cylindrical portion 31B of the rotation/linear motion ramp 31. The ball grooves 29D and 31D at the rotational ramp 29 and the rotation/linear motion ramp 31 may have a recess at a certain position of the inclination along the circumferential direction, or a change at a certain position in the inclination.

The base nut 33 is formed into a bottomed cylindrical shape including the bottom wall 33A and the cylindrical portion 33B extending from the outer circumferential edge of the bottom wall 33A toward the disk rotor 150. The male screw portion 33C, which is screwed with the male screw portion 31C formed on the outer circumferential surface of the cylindrical portion 31B of the rotation/linear motion ramp 31, is formed on the inner circumferential surface of the cylindrical portion 33B. The insertion hole 33D, through which the cylindrical portion 29B of the rotational ramp 29 is inserted, is formed at a substantially central point of the bottom wall 33A of the base nut 33.

Then, the cylindrical portion 29B of the rotational ramp 29 is inserted through the insertion hole 33D of the bottom wall 33A of the base nut 33 in such a manner that the rotation/linear motion plate 31A of the rotation/linear motion ramp 31, and the rotational plate 29A of the rotational ramp 29 are contained in the cylindrical portion 33B of the base nut 33. Further, the female screw portion 33C of the cylindrical portion 33B of the base nut 33 is screwed with the screw portion 31C of the cylindrical portion 31B of the rotation/linear motion ramp 31, and the bottom wall 33A of the base nut 33 is supported between the bottom wall 9 of the bore 10 and the rotational plate 29A of the rotational ramp 29 via thrust bearings 58 and 30. As a result, the base nut 33 is supported rotatably relative to the bottom wall 9 of the bore 10 via the thrust bearing 58 and a thrust washer 57. However, the base nut 33 is prevented from rotating relative to the retainer 26 by fitted engagement of a plurality of protrusion portions 33E formed at the outer circumference of the base nut 33 with recess portions 26G formed at the retainer 26, which will be described below. Further, a plurality of tab portions 26F is formed at the end of a large-diameter portion 26A of the retainer 26 that is closer to the bottom wall 9 of the bore 10. Each of the tab portions 26F are formed by folding the retainer 26 in the central direction after installing the base nut 33 at a predetermined position in the retainer 26. The plurality of tab portions 26F prevents the base nut 33 from moving toward the planetary gear reduction mechanism 36.

The male screw portion 31C of the cylindrical portion 31B of the rotation/linear motion ramp 31 and the female screw portion 33C formed at the cylindrical portion 33B of the base nut 33 are formed in such a manner that, in a case where the rotation/linear motion ramp 31 moves away from the rotational ramp 29 due to a rotation of the rotational ramp 29 in one direction and rolling motions of the balls 32 between the facing ball grooves 29D and 31D at the rotational ramp 29 and the rotation/linear motion ramp 31, a rotation of the rotation/linear motion ramp 31 in the same direction as the rotational ramp 29 causes the rotation/linear motion ramp 31 to move away from the base nut 33.

The balls 32 are made of steel balls as rolling members, and are disposed between the ball grooves 29D of the rotational plate 29A of the rotational ramp 29 and the ball grooves 31D of the rotation/linear motion plate 31A of the rotation/linear motion ramp 31, respectively.

Application of a rotational torque to the rotational ramp 29 causes the balls 32 to roll between the ball grooves 29D of the rotational ramp 29 and the ball grooves 31D of the rotation/linear motion ramp 31. When the balls 32 roll, the rotation/linear motion ramp 31 axially moves forward while rotating relative to the base nut 33 in a case where the base nut 33 does not rotate relative to the bore 10, since the rotation/linear motion ramp 31 is screwed with the base nut 33. At this time, the rotation/linear motion ramp 31 axially moves forward until the rotational torque of the rotation/linear motion ramp 31 generated by rolling motions of the balls 32 is balanced with a rotation resistance torque of the male screw portion 31 of the rotation/linear motion ramp 31 and the female screw portion 33C of the base nut 33. Further, the male screw portion 31C of the rotation/linear motion ramp 31 and the female screw portion 33C of the base nut 33 are arranged to form a screwed portion having a reversed efficiency of 0 or lower, i.e., having high irreversibility to prevent the base nut 33 from rotating due to an axial load applied from the piston 12 to the rotation/linear motion ramp 31.

The retainer 26 is formed into a substantially cylindrical shape as a whole. The retainer 26 includes the large-diameter portion 26A positioned closest to the bottom wall 9 of the bore 10, the reduced diameter portion 26B having a diameter decreasing from the large-diameter portion 26A toward the opening 7A of the bore 10, and a small-diameter portion 26C extending from the reduced diameter portion 26B toward the opening 7A of the bore 10. The plurality of tab portions 26F, which is engaged with the base nut 33, is formed at end of the large-diameter portion 26A closer to the bottom wall 9 of the bore 10 by folding the retainer 26 (the right side of the large-diameter portion 26A in FIG. 2) by partially folding the large-diameter portion 26A toward the center side. Further, the plurality of elongated grooves 26E is formed at the reduced diameter portion 26B of the retainer 26 along the circumferential direction. The plurality of corresponding protrusion portions 53B formed at the flange portion 53A of the push rod 53 is fitted in the elongated grooves 26E.

A coil portion 65A of a spring clutch 65 as a unidirectional clutch member is wound around the outer circumference of the small-diameter portion 26C of the retainer 26. The spring clutch 65 is configured to provide a rotational torque according to a rotation of the retainer 26 in one direction but hardly provide a rotational torque according to a rotation of the retainer 26 in the other direction. In the present embodiment, the spring clutch 65 provides a rotation resistance torque against the rotational direction when the nut 55 moves toward the ball and ramp mechanism 28. The rotation resistance torque of the spring clutch 65 is larger than the rotation resistance torque generated between the male screw portion 31C of the rotation/linear motion ramp 31 and the female screw portion 33C of the base nut 33 by the biasing force of the coil spring 27, when the rotation/linear motion ramp 31 and the base nut 33 axially move toward each other. Further, a ring portion 65B is formed at the end of the spring clutch 65 closer to the opening 7A of the bore 10 (the left side in FIG. 2) in abutment with the flat surface portions 12C of the piston 12 in a similar manner to the protrusion portions 54A of the nut 55. As a result, the spring clutch 65 is prevented from moving relative to the piston 12 in the rotational direction while being allowed to move relative to the piston 12 in the axial direction.

As illustrated in FIG. 1, an ECU 70, which includes an electronic control apparatus as a control unit for driving and controlling the motor 38, is connected to the motor 38. A parking switch 71, which a driver operates to instruct application/release of parking brake, is connected to the ECU 70. Further, the ECU 70 has a function of actuating the brake system based on a signal from the not-illustrated vehicle side independently of an operation of the parking switch 71, such as a function of maintaining the vehicle at a braked state by actuating the caliper 4 when a parked state continues for a certain time, and a function of working as an alternative of ABS by causing the motor 38 to intermittently rotate in a normal direction and a reverse direction when a failure occurs at the hydraulic pressure control apparatus.

As described above, in the present embodiment, the bore 10 of the caliper main body 6, the piston 12, the push rod 53 and the nut 55 of the screw mechanism 52, the rotational ramp 29 and the rotation/linear motion ramp 31 of the ball and ramp mechanism 28, and the sun gear 44B of the planetary gear reduction mechanism 36 (the second reduction gear 44) are disposed concentrically. In the present embodiment, the respective components are arranged in such a manner that the distance L1 between the central axis (the shaft 62) of the first reduction gear 43 to the central axis (the shaft 63) of the bore 10 is longer than the distance L2 between the rotational shaft 41 of the motor 38 and the central axis (the shaft 63) of the bore 10. This arrangement prevents the large gear 43A of the first reduction gear 43 and the large gear 44A of the second reduction gear 44 from axially overlapping each other, thereby enabling a reduction in the axial length of the present disk brake apparatus 1 compared to the conventional disk brake. Therefore, it is possible to improve the mountability of the disk brake apparatus to the vehicle. Further, in the present embodiment, as illustrated in FIG. 3, the central axis (the shaft 62) of the first reduction gear 43 is disposed in linear alignment with the central axis of the bore 10 and the rotational shaft 41 of the motor 38 in the rotational direction of the disk rotor 150. In other words, the central axis (the shaft 62) of the first reduction gear 43, the rotational shaft 41 of the motor 38, and the central axis (the shaft 63) of the bore 10 are linearly aligned with one another in this order in the rotational direction of the disk rotor 150. This arrangement enables the motor 38 to be disposed without protruding in the radial direction of the disk rotor 150 of the caliper main body 6. Therefore, it is possible to improve the mountability of the disk brake apparatus to the vehicle. The central axis (the shaft 62) of the first reduction gear 43, the central axis of the bore 10, and the rotation shaft 41 of the motor 38 may be arranged concentrically with the disk rotor 150. In the present embodiment, as illustrated in FIG. 3, the central axis (the shaft 62) of the first reduction gear 43 is disposed on an extension of the line connecting the central axis of the bore 10, i.e., the central axis of the cylinder portion 7 and the rotational shaft 41 of the motor 38. This arrangement facilitates attachment of the bolts 77 for fixing the slide pins 78 to the caliper main body 6 and detachment of the bolts 77, and thereby improves the manufacturing efficiency of the disk brake apparatus 1 and makes the maintenance of the disk brake apparatus 1 easer. Further, it becomes possible to easily mount the brake disk apparatus 1 to the vehicle, since a space is generated around the bolt holes of the bracket 5.

Next, the function of the disk brake apparatus 1 according to the present embodiment will be described. First, the disk brake apparatus 1 functions to brake the vehicle in the following manner, when the disk brake apparatus 1 works as a normal hydraulic brake in response to an operation of the brake pedal. When a driver presses the brake pedal, a hydraulic pressure according to the force pressing the brake pedal is supplied from a master cylinder into the hydraulic chamber 13 in the caliper 4 via a hydraulic pressure circuit (both the master cylinder and the hydraulic pressure circuit are not illustrated). As a result, the piston 12 moves forward (moves to the left side in FIG. 1) from an original position when the brake is not in operation, while elastically deforming the piston seal 11, thereby pressing the inner brake pad 2 against the disk rotor 150. Then, the caliper main body 6 moves relative to the bracket 5 in the right direction in FIG. 1 due to the reactive force from the pressing force of the piston 12, thereby pressing the outer brake pad 3 against the disk rotor 150 by the claw portion 8. As a result, the disk rotor 150 is sandwiched between the pair of inner and outer brake pads 2 and 3, whereby a braking force is generated to be applied to the vehicle.

Then, when the driver releases the brake pedal, the supply of the hydraulic pressure from the master cylinder stops, whereby the hydraulic pressure reduces in the hydraulic pressure chamber 13 of the caliper 4. As a result, the piton 12 moves backward to the original position since the elastic deformation of the piston 11 is eliminated, thereby releasing the braking force applied to the vehicle. When piston 12 has to move by an increased amount beyond the elastic deformation amount of the piston seal 11 due to wear of the inner and outer brake pads 2 and 3, a slip is generated between the piston 12 and the piston seal 11. The original position of the piston 12 is displaced relative to the caliper main body 6 due to this slip, thereby adjusting a pad clearance to a certain distance.

Next, the function as parking brake, which is an example of a function of maintaining a parked state of the vehicle, will be described. FIG. 1 illustrates the disk brake apparatus 1 when the brake pedal is not operated and the parking brake is released. When a driver operates the parking switch 71 to actuate the parking brake from this state, the ECU 70 drives the motor 38, and the sun gear 44B of the planetary gear reduction mechanism 36 rotates via the multi-stage spur gear reduction mechanism 37. The rotation of the sun gear 44B causes the carrier 48 to rotate via the planetary gears 45. The rotational force of the carrier 48 is transmitted to the rotational ramp 29.

At this time, the biasing force of the coil spring 27 is applied to the rotation/linear motion ramp 31 of the ball and ramp mechanism 28 via the push rod 53. Therefore, a thrust force of a certain level or more, i.e., a rotational torque T1 is required to cause the rotation/linear motion ramp 31 to move forward (to the left in FIG. 2) relative to the caliper main body 6. On the other hand, a rotational torque T2 required to cause a rotation of the push rod 53 is sufficiently smaller than the rotational torque T1 required to cause the rotation/linear motion ramp 31 to move forward, when the pair of inner and outer brake pads 2 and 3 are out of abutment with the disk rotor 150 and a pressing force is not applied from the piston 12 to the disk rotor 150. Further, when the parking brake is actuated, a rotation resistance torque T3 is neither provided by the spring clutch 65.

Therefore, during an initial stage of transmission of a rotational force from the carrier 48 to the rotational ramp 29, the rotation/linear motion ramp 31 does not move forward, and the rotational ramp 29 and the rotation/linear motion ramp 31 starts to rotate together. Most of the rotational force at this time except for an amount corresponding to a mechanical loss is transmitted to the screw mechanism 52 via the screwed portion between the male screw portion 31C of the rotation/linear motion ramp 31, the female spring portion 33C of the base nut 33, the retainer 26, and the push rod 53, thereby activating the screw mechanism 52. That is, the carrier 48 causes the rotational ramp 29, the rotation/linear motion ramp 31, the base nut 33, the retainer 26, and the push rod 53 to integrally rotate all together by its rotational force. This rotation of the push rod 53 causes the nut 55 to move forward (move in the left direction in FIG. 1). Then, the inclined surface 54B of the flange portion 54 of the nut 55 is brought into abutment with the inclined surface 12D of the piston 12 to press the inclined surface 12D, thereby causing the piston 12 to move forward.

When the motor 38 is further driven, and the pressing force starts to be applied from the piston 12 to the disk rotor 150 by an operation of the screw mechanism 52, this leads to an increase in the rotation resistance generated at the screwed portion between the male screw portion 53C of the push rod 53 and the female screw portion 55C of the nut 55 due to an axial force generated according to the pressing force, thereby increasing the rotational torque T2 required to cause the nut 55 to move forward. Then, the required rotational torque T2 increases to become larger than the rotational torque T1 required to actuate the ball and ramp mechanism 28, i.e., cause the rotation/linear motion ramp 31 to move forward. As a result, the rotation of the push rod 53 stops, and the rotation of the base nut 33 stops via the retainer 26 prevented from rotating relative to the push rod 53. Then, at this time, the rotation/linear motion ramp 31 axially moves forward while rotating, thereby causing the piston 12 to move forward via the screw mechanism 52, i.e., the push rod 53 and the nut 55 to increase the pressing force applied from the piston 12 to the disk rotor 150. At this time, the rotation/linear motion ramp 31 receives a sum of a thrust force generated at the ball grooves 31D, and a thrust force generated by the screwed engagement with the base nut 33 due to the application of the rotational torque from the rotational ramp 29. In the present embodiment, the screw mechanism 52 is first actuated to cause the nut 55 to move forward, thereby causing the piston 12 to move forward to acquire a pressing force to the disk rotor 150. Therefore, the actuation of the screw mechanism 52 enables compensation for wear of the pair of inner and outer brake pads 2 and 3 over time.

Then, the ECU 70 continues to drive the motor 38 until the pressing force from the pair of inner and outer brake pads 2 and 3 to the disk rotor 150 reaches a predetermined value, i.e., for example, the electric current value of the motor 38 reaches a predetermined value. After that, after the pressing force to the disk rotor 150 reaches the predetermined value, the ECU 70 stops the power supply to the motor 38. Accordingly, at the ball and ramp mechanism 28, the rotational ramp 29 stops rotating, thereby ending the application of the thrust force to the rotation/linear motion ramp 31 through rolling operations of the balls 32 between the ball grooves 29D and 31D. The reactive force from the pressing force to the disk rotor 150 is applied to the rotation/linear motion ramp 31 via the piston 12 and the screw mechanism 52, but the male screw portion 31C of the rotation/linear motion ramp 31 is screwed with the female screw portion 33C of the base nut 33 in such a manner that reverse operation is impossible. Therefore, the rotation/linear motion ramp 31 does not rotate, maintaining the parked state. As a result, the braking force is maintained, completing actuation of the parking brake.

The parking brake is released in the following manner. The ECU 70 drives the motor 38 in the opposite direction from the direction at the time of actuation of the parking brake to drive the motor 38 and drives the motor 38 in the rotational direction for returning the piston 12, i.e., displacing the piston 12 away from the disk rotor 150, based on a parking release operation of the parking switch 71. Driving the motor 38 in this manner causes the multi-stage spur gear reduction mechanism 37 and the planetary gear reduction mechanism 36 to operate in the direction for returning the piston 12. Then, the ball and ramp mechanism 28 returns to its original position, thereby completing a release of the parking brake. The ECU 70 controls the motor 38 to stop at a position where the piston 12 is spaced apart from the nut 55 by an appropriate distance.

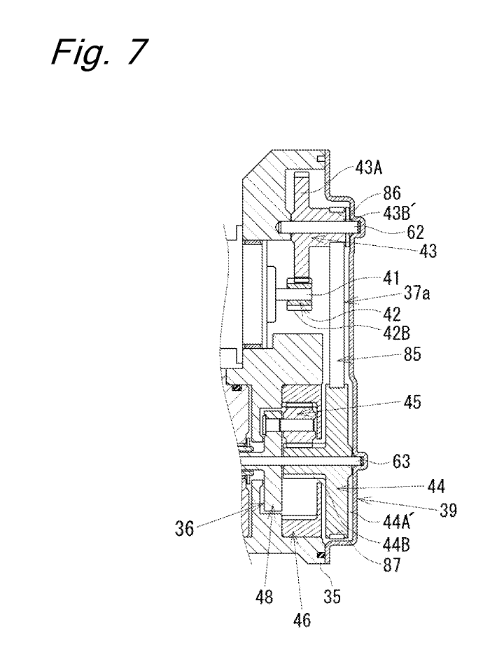

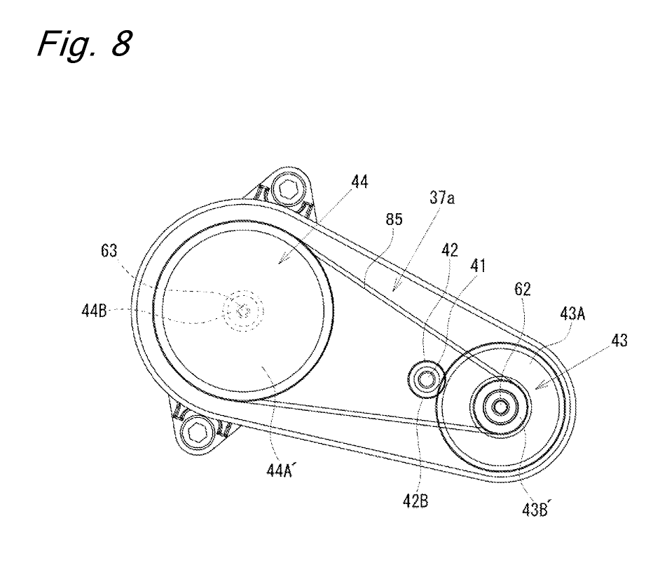

Next, a modification of the multi-stage spur gear reduction mechanism 37 in the disk brake apparatus 1 according to the present embodiment will be described based on FIGS. 7 and 8. The multi-stage spur gear reduction mechanism 37a includes a pinion gear 42, a first reduction gear 43, a second reduction gear 44, and a belt 85 as a transmission member that does not reduce the speed. The first reduction mechanism 43 includes a large gear 43A as a large-diameter rotational portion meshed with a gear 42B of the pinion gear 42, and a small-diameter axial portion 43B′ as a small-diameter rotational portion axially extending from the large gear 43A. The large gear 43A and the small-diameter axial portion 43B′ are integrally formed. The second reduction gear 44 includes a large-diameter axial portion 44A′ (a large-diameter rotational portion), and a small-diameter sun gear 44B (a small-diameter rotational portion) formed to axially extend from the large-diameter axial portion 44A′. The large-diameter axial portion 44A′ and the sun gear 44B are integrally formed. The belt 85 is wound around a belt groove portion 86 formed at the small-diameter axial portion 43B′ of the first reduction mechanism 43 and a belt groove 87 formed at the large-diameter axial portion 44A′ of the second reduction mechanism 44. Due to this configuration, a rotational force of the rotational shaft 41 of the motor 38 is transmitted from the first reduction mechanism 43 to the second reduction mechanism 44 via the belt 85. In the present embodiment, the first reduction gear 43 and the second reduction gear 44 may be configured in such a manner that the large-diameter rotational portion and the small-diameter rotational portion are separate members fixed to each other by, for example, fitted engagement, bonding, or screwing, as long as the large-diameter rotational portion and the small-diameter rotational portion are integrally joined. Further, the large-diameter rotational portion and the small-diameter rotational portion may be even spaced apart from each other while they are fixed to a same shaft.

As described above, in the disk brake 1 according to the present embodiment, the respective components are arranged in such a manner that the distance L1 between the central axis (the shaft 62) of the first reduction gear 43 and the central axis (the shaft 63) of the bore 10 is longer than the distance L2 between the rotational shaft 41 of the motor 38 and the central axis (the shaft 63) of the bore 10, so that the large gear 43A of the first reduction gear 43 and the large gear 44A of the second reduction gear 44 do not axially overlap each other, unlike the conventional technique (refer to Japanese Patent Application Public Disclosure No. 2010-1692480. Therefore, it is possible to reduce the axial length of the disk brake apparatus 1 compared to the conventional technique, thereby improving the mountability to the vehicle

In the present embodiment, the piston thrust mechanism 34 includes the ball and ramp mechanism 28 and the screw mechanism 52. However, the present invention is not limited thereto. The piston thrust mechanism 34 may include only the screw mechanism 52, or may include another type of rotation/linear motion conversion mechanism. Further, in the present embodiment, the multi-stage spur gear reduction mechanism 37 is used as a reduction mechanism for increasing a rotational force of the motor 38, but may be replaced with any of various kinds of reduction mechanisms such as a reduction mechanism configured to transmit a rotational force by a friction force through abutment of a part of rotational members not having teeth. Further, in the present embodiment, the planetary gear reduction mechanism 36 is used as the reduction mechanism, but the reduction mechanism does not necessarily have to be the planetary gear reduction mechanism 36, and may be embodied by any reduction mechanism capable of setting a desired speed reduction ratio, such as another differential reduction mechanism or a wave gear apparatus. The present embodiment has been described based on an example in which the respective axes are linearly aligned in such a manner that the distance L1 between the central axis of the first reduction gear 43 and the central axis of the bore 10 (the sun gear 44B) of the cylinder portion 7 is longer than the distance L2 between the rotational shaft 41 of the motor 38 and the central axis of the sun gear 44B. However, the respective axes do not necessarily have to be linearly aligned. For example, the central axis of the first reduction gear 43 may be positioned offset from the line connecting the central axis of the sun gear 44B and the rotational shaft 41 of the motor 38 and closer to the cylinder portion 7, within the range capable of satisfying the condition L1>12. In this case, it is possible to maintain the mountability of the disk brake apparatus 1 by arranging the first reduction gear 43 in such a manner that the central axis of the first reduction gear 43 is positioned closer to the cylinder portion 7 without being displaced outside in the radial direction of the disk rotor 150.

According to the disk brake apparatus of the above-described embodiment, it is possible to improve the mountability to the vehicle.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Applications No. 2011-212782 filed on Sep. 28, 2011. The entire disclosure of No. 2011-212782 filed on Sep. 28, 2011 including specification, claims, drawings and summary is incorporated herein by reference in its entirety.

What is claimed is:

1. A disk brake apparatus comprising:
a pair of pads disposed on opposite sides of a disk rotor;
a piston configured to press one of the pair of pads against the disk rotor;
a caliper main body including a cylinder in which the piston is movably disposed;
an electric motor disposed at the caliper main body and arranged in alignment with the cylinder in a circumferential direction of the disk rotor;
a speed reduction mechanism capable of transmitting a rotational force from the electric motor while increasing the rotational force by a plurality of rotational members; and
a piston thrust mechanism to which the rotational force is transmitted from the speed reduction mechanism, the piston thrust mechanism being configured to move forward the piston to a braking position, wherein
the plurality of rotational members includes a first rotational member and a second rotational member,
the first rotational member is disposed in such a manner that the rotational force is transmitted from the electric motor to the first rotational member, and includes a large-diameter rotational portion connected to the electric motor, and a small-diameter rotational portion formed coaxially with the large-diameter rotational portion and connected to a transmission member configured to transmit the rotational force to the second rotational member, and
the first rotational member is disposed in such a manner that a distance between a central axis of the first rotational member and a central axis of the cylinder is longer than a distance between a rotational axis of the electric motor and the central axis of the cylinder.

2. The disk brake according to claim 1, wherein the central axis of the first rotational member is arranged in alignment with the central axis of the cylinder and the rotational axis of the electric motor in a rotational direction of the disk rotor.

3. The disk brake according to claim 1, wherein the central axis of the first rotational member is positioned on an extension of a line connecting the central axis of the cylinder and the rotational axis of the electric motor.

4. The disk brake according to claim 1, wherein the second rotational member among the plurality of rotational members is disposed so as to transmit the rotational force to the piston thrust mechanism,
the transmission member is a transmission member that does not reduce a speed, and
the rotational force is transmitted from the first rotational member to the second rotational member via the transmission member that does not reduce the speed.

5. The disk brake according to claim 1, wherein the caliper main body is slidably disposed via a slide pin at a bracket including a fixation portion fixed to a non-rotational portion of a vehicle, and
the first rotational member is disposed between the fixation portion and the slide pin in a radial direction of the disk rotor.

6. The disk brake according to claim 1, wherein the plurality of rotational members comprises stepped reduction gears.

7. The disk brake according to claim 6, wherein a spur gear is disposed between a small-diameter rotational portion of one reduction gear among the plurality of reduction gears and a large-diameter rotational portion of another reduction gear among the plurality of reduction gears.

8. The disk brake according to claim 7, wherein the speed reduction mechanism includes a planetary gear reduction mechanism, and the planetary gear reduction mechanism is disposed between the another reduction gear and the piston thrust mechanism.

9. The disk brake according to claim 1, wherein a belt is attached to the plurality of rotational members, and a rotation is transmitted via the belt.

10. A disk brake comprising:
a caliper main body including a cylinder in which a piston is movably disposed, the piston being configured to press one of a pair of pads against a disk rotor, the pair of pads being disposed on opposite sides of the disk rotor;
an electric motor disposed at the caliper main body and arranged in alignment with the cylinder in a circumferential direction of the disk rotor;
a speed reduction mechanism capable of transmitting a rotational force from the electric motor while increasing the rotational force by a plurality of rotational members; and
a piston thrust mechanism disposed coaxially with the cylinder and configured to move forward the piston when the rotational force is transmitted from the speed reduction mechanism, wherein
the plurality of rotational members includes a first rotational member,
the first rotational member is disposed in such a manner that the rotational force is transmitted from the electric motor to the first rotational member and comprises a stepped reduction gear, and
a central axis of the first rotational member is disposed at a position farther away from the cylinder than a rotational axis of the motor.

11. The disk brake according to claim 10, wherein the central axis of the first rotational member is arranged in alignment with the central axis of the cylinder and the rotational axis of the electric motor in a rotational direction of the disk rotor.

12. The disk brake according to claim 10, wherein the central axis of the first rotational member is positioned on an extension of a line connecting the central axis of the cylinder and the rotational axis of the electric motor.

13. The disk brake according to claim 10, wherein the plurality of rotational members further includes a second rotational member disposed so as to transmit the rotational force to the piston thrust mechanism, and
the rotational force is transmitted from the first rotational member to the second rotational member via a transmission member that does not reduce a speed.

14. The disk brake according to claim 10, wherein the caliper main body is slidably disposed via a slide pin at a bracket including a fixation portion fixed to a non-rotational portion of a vehicle, and
the first rotational member is disposed between the fixation portion and the slide pin in a radial direction of the disk rotor.

15. The disk brake according to claim 10, wherein the plurality of rotational members further includes a second rotational member comprising a stepped reduction gear,
each of the reduction gears, which the first rotational member and the second rotational member comprise, includes a large-diameter gear portion and a small-diameter gear portion formed coaxially with the large-diameter gear portion, and
a spur gear is disposed between the small-diameter gear portion of the reduction gear of the first rotational member and the large-diameter gear portion of the reduction gear of the second rotational member.

16. A disk brake comprising:
a bracket including a fixation portion fixed to a non-rotatable portion of a vehicle, the bracket being configured to slidably support a pair of pads disposed on opposite sides of a disk rotor;
a piston configured to press one of the pair of pads against the disk rotor;
a caliper main body including a cylinder in which the piston is slidably disposed, the caliper main body being slidably disposed at the bracket via a slide pin;
an electric motor disposed at the caliper main body, and arranged in alignment with the cylinder in a circumferential direction of the disk rotor;
a speed reduction mechanism capable of transmitting a rotational force from the electric motor while increasing the rotational force by a plurality of rotational members; and
a piston thrust mechanism configured to move forward the piston when the rotational force is transmitted from the speed reduction mechanism, wherein
the plurality of rotational members includes a first rotational member and a second rotational member,
the first rotational member is disposed in such a manner that the rotational force is transmitted from the electric motor to the first rotational member and includes a large-diameter rotational portion connected to the electric motor, and a small-diameter rotational portion formed coaxially with the large-diameter rotational portion and connected to a transmission member configured to transmit the rotational force to the second rotational member, and
the first rotational member is disposed between the fixation portion and the slide pin in a radial direction of the disk rotor.

17. The disk brake according to claim 16, wherein the central axis of the first rotational member is arranged in alignment with the central axis of the cylinder and the rotational axis of the electric motor in a rotational direction of the disk rotor.

18. The disk brake according to claim 16, wherein the central axis of the first rotational member is positioned on an extension of a line connecting the central axis of the cylinder and the rotational axis of the electric motor.

19. The disk brake according to claim 16, wherein the second rotational member among the plurality of rotational members is disposed so as to transmit the rotational force to the piston thrust mechanism,
the transmission member is a transmission member that does not reduce a speed, and
the rotational force is transmitted from the first rotational member to the second rotational member via the transmission member that does not reduce the speed.

20. The disk brake according to claim 16, wherein the plurality of rotational members comprises stepped reduction gears, and
a spur gear is disposed between a small-diameter rotational portion of one reduction gear among the plurality of reduction gears and a large-diameter rotational portion of another reduction gear among the plurality of reduction gears.
